(19) United States
(12) Patent Application Publication
(10) Pub. No.: US 2006/0141989 A1
(43) Pub. Date: Jun. 29, 2006

(54) Method for selectively deleting messages received by a radio telephone

(76) Inventors: Feng Jun Guo, Shanghai (CN); Xia Jin, Shanghai (CN); Li Xin Zhen, Shanghai (CN)

Correspondence Address: MOTOROLA INC, 600 NORTH US HIGHWAY 45, ROOM AS437, LIBERTYVILLE, IL, 60048-5343, US

(21) Appl. No.: 10/562,992

(22) PCT Filed: Jun. 22, 2004
(86) PCT No.: PCT/EP04/51195

§ 371 Date: Dec. 27, 2005

(51) Int. Cl. H04L 12/58

(52) U.S. Cl. 455/412.1; 455/456.1

(57) ABSTRACT

A method (20) for selectively deleting messages received by a radio telephone (1). The method (20) includes detecting when the telephone (1) has moved from a previous coverage area to a current coverage area and selectively obtaining a set of coverage area specific messages (Mset) stored in a memory (16,18) associated with the telephone (1), the coverage area specific messages being from a set of messages received when the telephone was in the previous coverage area. The method (1) provides for and automatically deleting the coverage area specific messages from the memory (16,18) when the telephone (1) is in the current coverage area.

### FIELD OF THE INVENTION

This invention relates to selectively deleting messages received by a radio telephone. The invention is particularly useful for, but not necessarily limited to, deleting broadcast advertisement messages received whilst the radio telephone roams in different coverage areas.

### BACKGROUND OF THE INVENTION

Sending messages to radio telephones by Short Message Service (SMS) or Multimedia Messaging Service (MMS) is becoming common practice. However, due to relatively small memory capacity allocated to messages, there is a limit to the number of messages a radio telephone can receive before previously stored messages must be deleted or stored another memory medium or location. Furthermore, service providers, advertising agencies and other organisations frequently send generic advertising messages to radio telephones that roam into a specific coverage area. These generic advertising messages are usually coverage area specific and may include local information, places to dine, economical telephone numbers for long distance and overseas calls. However, once a radio telephone roams out of the specific coverage area these generic messages do not need to remain stored in the limited memory available. Also, it is highly likely that the same messages will be received again when the radio telephone returns to the specific coverage area. It would therefore be useful if there existed a method for selectively deleting such messages when the radio telephone roams out of the specific coverage area in order to release valuable memory space for future received messages.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed.

### SUMMARY OF THE INVENTION

According to one aspect of the invention there is provided a method for selectively deleting messages received by a radio telephone, the method being effected by the telephone and the method comprising:

Detecting when the telephone has moved from a previous coverage area to a current coverage area;

Selectively obtaining a set of coverage area specific messages stored in a memory associated with the telephone, the coverage area specific messages being from a set of messages received when the telephone was in the previous coverage area; and

Automatically deleting the coverage area specific messages from the memory.

The selectively obtaining may be effected by only selecting messages that are presumed to be generic messages sent by a service provider of the previous coverage area.

Suitably, the selectively obtaining may be effected by only selecting messages sent from one or more telephone numbers that do not correspond with any numbers stored in a telephone book database of known personal numbers, inserted by a user, that are identifiable by the telephone.

The selectively obtaining may be effected by only selecting messages that have a content presumed to include generic advertising.

Suitably, the content may be presumed to include generic advertising by searching each of the messages for selected words.

Suitably, selectively obtaining may include requesting confirmation from a user that a message is one of the coverage area specific messages.

The obtaining can be effected after arrival of the telephone at the current coverage area. Alternatively, the obtaining can be effected before the telephone leaves the previous coverage area.

Suitably, the detecting is characterized by detecting that the telephone has moved from the previous coverage area to the current coverage area when there is a change in a service provider cell communicating with the telephone. The detecting may also be characterized by detecting that the telephone has moved from the previous coverage area to the current coverage area when the telephone moves from one cell to another cell or from one country to another country.

### BRIEF DESCRIPTION OF THE DRAWINGS

In order that the invention may be readily understood and put into practical effect, reference will now be made to a preferred embodiment as illustrated with reference to the accompanying drawings in which:

FIG. 1 is a block diagram illustrating an embodiment of a radio telephone in accordance with the invention;

FIG. 2 is a flow diagram illustrating a method step for selectively deleting messages received by a radio telephone of FIG. 1; and

FIG. 3 is a flow diagram illustrating a detailed method for selectively obtaining a set of selected messages as used in the method of FIG. 2.

### DETAILED DESCRIPTION OF A PREFERRED EMBODIMENT OF THE INVENTION

In the drawings, like numerals on different Figs are used to indicate like elements throughout. With reference to FIG. 1, there is illustrated a radio telephone 1 comprising a radio frequency communications unit 2 coupled to be in communication with a processor 3. An input interface in the form of a screen 5 and a keypad 6 are also coupled to be in communication with the processor 3.

The processor 3 includes an encoder/decoder 11 with an associated Read Only Memory (ROM) 12 storing data for encoding and decoding voice or other signals that may be transmitted or received by the radio telephone 1. The processor 3 also includes a microprocessor 13 coupled, by a common data and address bus 17, to an encoder/decoder 11 and an associated character Read Only Memory (ROM) 14, a Random Access Memory (RAM) 4, static programmable memory 16 and a removable SIM module 18. The static programmable memory 16 and SIM module 18 each can store, amongst other things, selected incoming text messages and a telephone book database TDb.

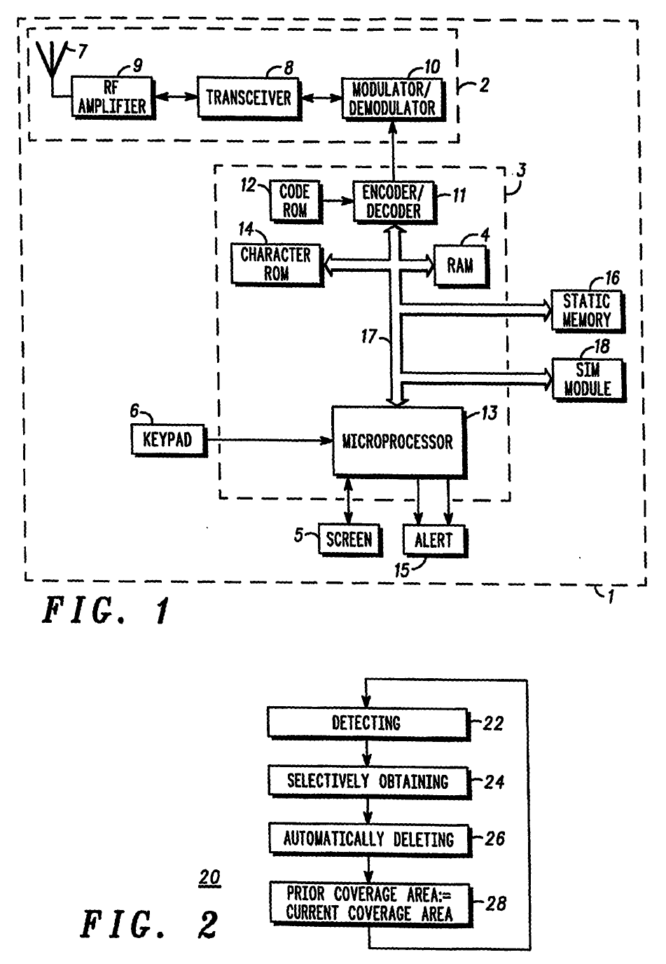

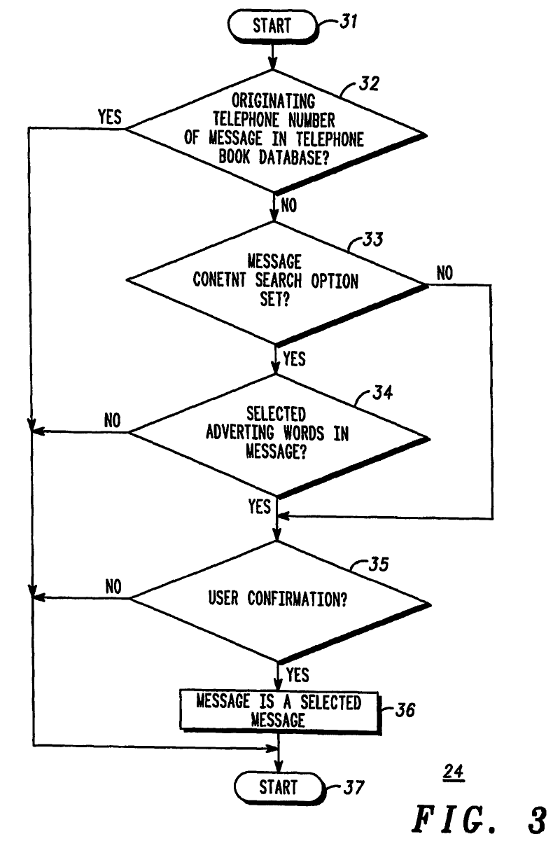

The micro-processor 13 has ports for coupling to the keypad 6, the screen 5 and an alert module 15 that typically contains a speaker, vibrator motor and associated drivers. The character Read only memory 14 stores code for decoding or encoding text messages that may be received by the communication unit 2, input at the keypad 6. In this embodiment the character Read Only Memory 14 also stores operating code (OC) for micro-processor 13 and code for performing a method as described below with reference to FIGS. 2 and 3.

The radio frequency communications unit 2 is a combined receiver and transmitter having a common antenna 7. The communications unit 2 has a transceiver 8 coupled to antenna 7 via a radio frequency amplifier 9. The transceiver 8 is also coupled to a combined modulator/demodulator 10 that couples the communications unit 2 to the processor 3.

Referring to FIG. 2 there is illustrated a method 20 for selectively deleting messages received by the radio telephone 1 through the radio frequency communications unit 2. The method 20 is effected by the processor 3 of the radio telephone 1 and the method 20 comprises a detecting step 22 for detecting when the telephone 1 has moved from a previous coverage area to a current coverage area. This is typically detected when there is a change in a service provider cell communicating with the telephone 1. It may also occur when the telephone 1 moves from one cell to another cell or from one country to another country. Other scenarios are possible as will be apparent to a person skilled in the art and coverage area simply means a geographic area having a boundary determined by a radio telephone network.

After the step of detecting 22 the processor 3 performs a selectively obtaining step 24 for Selectively obtaining a set of coverage area specific messages (Mset) stored in the memory associated with the telephone. This memory is typically the static memory 16 or memory in the SIM module 18. Also, these coverage area specific messages Mset are from a set of messages received when the telephone was in the previous coverage area. These messages Mset are typically SMS or MMS messages as will be apparent to a person skilled in the art, however, other types of message formats are possible.

The processor 3 then controls the method 20 to perform an automatically deleting step 26 for automatically deleting the set of coverage area specific messages Mset from the memory 16 or memory in the SIM module 18. At a step 28, the previous coverage area (or prior coverage area) becomes the current coverage area and the method 20 returns to step 22. The processor 3 will monitor data received by the from the radio frequency communications unit 2 to determine that the telephone 1 has moved to another coverage area and the method 20 will therefore repeat steps 24 to 28.

Typically, step 24 for selectively obtaining may be effected by only selecting messages that are presumed to be generic messages sent by a service provider of the previous coverage area. More specifically, referring to FIG. 3, there is illustrated a detailed explanation of one embodiment for performing the selectively obtaining step 24. It should be noted that typically each of the messages are processed in turn by step 24 as described hereafter.

After a start step 31 the processor 3 determines at a test step 32 if an originating telephone number of a message MSG (the number being typically identified by a conventional caller identification function of the telephone 1) corresponds with any numbers stored in the telephone book database TDb of the telephone 1. If the originating telephone number of the message MSG does not correspond with any numbers (known personal numbers entered by a user) stored in the telephone book database TDb, then an option test 33 determines if the user wishes the message MSG to be searched for advertisement words or phrases that are indicative of the message MSG being a generic advertising message. If at step 33 it is determined that the user has preselected the option to search the message content, then a test step 34 determines if selected advertising words or phrases appear in the message MSG. Such words can be: “cost”, “cheap”, “rates”, “reasonable”, “competitive”, “comparable”, “savings”, “cost effective” and “information” “sale,“discount”, “for more”, “more information”, “more details” and the currency units “$”,“¥”.

If the selected advertising words or phrases appear in the message MSG then an optional user confirmation test may be performed asking a user to confirm that the message MSG (displayed on screen 5) is a coverage area specific message. In step 35, if the user confirms that the message MSG is an unwanted coverage specific or generic message then at a step 36, the message MSG is selected as a selected message and is added to the set of coverage area specific messages Mset. The selectively obtaining step 24 then terminates at an end step 37.

If at step 33 it is determined that the user has not preselected the option to search the message content then the test step 34 is bypassed. Also, if tests 34 and 35 return a negative result (a NO) or test 32 returns a positive result (a YES) then the message MSG is determined not to be a coverage area specific message and it is not selected as a selected message by step 36.

The selectively obtaining step 24 is repeated for other messages MSG received in the previous coverage area. However, it will be apparent to a person skilled in the art that the step 24 provides for only selecting messages sent from one or more telephone numbers that do not correspond with any numbers stored in a telephone book database TDb of known personal numbers, inserted by a user, that are identifiable by the telephone 1. The step 24 also provides for only selecting messages that have a content presumed to include generic in nature. This content includes advertisements or information typically associated with a specific coverage area such as cheap rate telephone service provider information, dining out details, shopping areas and any other type of generic advertising or area specific information.

As illustrated and described in the preferred embodiment, the obtaining step 24 is effected after arrival of the telephone at the current coverage area. However, the obtaining step 24 can be effected before the telephone leaves the previous coverage area.

Advantageously, the present invention provides for selectively deleting messages presumed to be generic coverage area specific messages when the radio telephone roams out of the specific coverage area. This therefore releases valuable memory space for future messages to be received.

The detailed description provides a preferred exemplary embodiment only, and is not intended to limit the scope, applicability, or configuration of the invention. Rather, the detailed description of the preferred exemplary embodiment provides those skilled in the art with an enabling description for implementing preferred exemplary embodiment of the invention. It should be understood that various changes may be made in the function and arrangement of elements without departing from the spirit and scope of the invention as set forth in the appended claims.

We claim:

1. A method for selectively deleting messages received by a radio telephone, the method being effected by the telephone and the method comprising:
detecting when the telephone has moved from a previous coverage area to a current coverage area;
selectively obtaining a set of coverage area specific messages stored in a memory associated with the telephone, the coverage area specific messages being from a set of messages received when the telephone was in the previous coverage area; and
automatically deleting the coverage area specific messages from the memory.

2. A method for selectively deleting messages, as claimed in claim 1, wherein the selectively obtaining is effected by only selecting messages that are presumed to be generic messages sent by a service provider of the previous coverage area.

3. A method for selectively deleting messages, as claimed in claim 1, wherein the selectively obtaining is effected by only selecting messages sent from one or more telephone numbers that do not correspond with any numbers stored in a telephone book database of known personal numbers, inserted by a user, that are identifiable by the telephone.

4. A method for selectively deleting messages, as claimed in claim 1, wherein the selectively obtaining is effected by only selecting messages that have a content presumed to include generic advertising.

5. A method for selectively deleting messages, as claimed in claim 4, wherein the content may be presumed to include generic advertising by searching each of the messages for selected words.

6. A method for selectively deleting messages, as claimed in claim 1, selectively obtaining may include requesting confirmation from a user that a message is one of the coverage area specific messages.

7. A method for selectively deleting messages, as claimed in claim 1, wherein the obtaining is effected after arrival of the telephone at the current coverage area.

8. A method for selectively deleting messages, as claimed in claim 1, wherein the obtaining is effected before the telephone leaves the previous coverage area.

9. A method for selectively deleting messages, as claimed in claim 1, wherein the detecting is characterized by detecting that the telephone has moved from the previous coverage area to the current coverage area when there is a change in a service provider cell communicating with the telephone.

10. A method for selectively deleting messages, as claimed in claim 1, wherein the detecting is characterized by detecting that the telephone has moved from the previous coverage area to the current coverage area when the telephone moves from one cell to another cell or from one country to another country.
